(19) United States
(12) Patent Application Publication
(10) Pub. No.: US 2007/0092364 A1
(43) Pub. Date: Apr. 26, 2007

(54) Low profile hook hoist

(76) Inventors: William S. Geise, Star City, IN (US); John Downing, Winamac, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/247,729

(22) Filed: Oct. 11, 2005

(51) Int. Cl. B60P 1/04

(52) U.S. Cl. 414/467

(57) ABSTRACT

A vehicle-mounted hook hoist for loading, transporting, dumping and unloading material handling containers, includes a vehicle having a main frame; and, a hook hoist assembly including a hoist frame, a tilt frame, an extension tube assembly, an articulating arm and motive means for moving said tilt frame, extension tube assembly and articulating arm; wherein the hoist frame has a rear hinge mount and is mounted to the main frame, the tilt frame has a rear and a pivot mount and is pivotally mounted at its pivot mount to the rear hinge mount of the hoist frame, and the extension tube is telescopically connected with the tilt frame to extend between a retracted position and an extended position; and, wherein the articulating arm is pivotally connected to the extension tube assembly to pivot between a retracted rest position and a rotatably extended position, and wherein the articulating arm includes a hook configured to engage with and move a container onto and off of the vehicle.

### FIELD OF THE INVENTION

The present invention relates to the field of transport vehicles, and more specifically, to vehicle-mounted hook hoists for loading, transporting, dumping and unloading waste handling containers and bulk goods containers.

### BACKGROUND OF THE INVENTION

Waste materials and bulk goods are frequently transported in very large material handling containers. A typical container of this type might measure 8′×18′×5′ with one or more openings for receiving desired materials. Vehicle-mounted hoists are used to load and transport such containers to another location for dumping and/or offloading. During the loading and unloading process, the container is typically inclined which can create an undesirable shifting of the container contents. It is desirable to reduce the angle at which such container is inclined during the loading and unloading procedures.

### SUMMARY OF THE INVENTION

Generally speaking, a vehicle-mounted hook hoist includes a hook hoist assembly operable to load and unload a large, material handling container whereby the load angle of such container is maintained at a very low angle.

A vehicle-mounted hook hoist for loading, transporting, dumping and unloading material handling containers, includes a vehicle having a main frame; and, a hook hoist assembly including a hoist frame, a tilt frame, an extension tube assembly, an articulating arm and motive means for moving said tilt frame, extension tube assembly and articulating arm; wherein the hoist frame has a rear hinge mount and is mounted to the main frame, the tilt frame has a rear and a pivot mount and is pivotally mounted at its pivot mount to the rear hinge mount of the hoist frame, and the extension tube is telescopically connected with the tilt frame to extend between a retracted position and an extended position; and, wherein the articulating arm is pivotally connected to the extension tube assembly to pivot between a retracted rest position and a rotatably extended position, and wherein the articulating arm includes a hook configured to engage with and move a container onto and off of the vehicle.

It is an object of the present invention to provide an improved hoist for loading, transporting, dumping and unloading material handling containers.

Further objects and advantages of the present invention will become apparent from the following description of the preferred embodiment

### BRIEF DESCRIPTION OF THE DRAWINGS

FIG. 1 is a side, elevational view of a vehicle-mounted, low profile hook hoist 10 in accordance with one embodiment of the present invention, and showing the hoist in both the forward, transport position 14 and the elevated, container dumping position 15 with a container thereon.

FIG. 2 is a side view of hoist frame 16 of hook hoist 10 of FIG. 1 and with the rear stabilizer assembly 39 in the down, stabilizing position.

FIG. 3 is a side view of hoist frame 16 of FIG. 2 and with the rear stabilizer assembly 39 in the up, transport position.

FIG. 4 is a side view of the extension tube cylinder 23 of extension tube assembly 18 of hook hoist 10 of FIG. 1.

FIG. 5 is a side view of the box tube 76 of extension tube assembly 18 of hook hoist 10 of FIG. 1.

FIG. 6 is a side view of the tilt frame 17 of hook hoist 10 of FIG. 1.

FIG. 7 is a side view of a tilt frame cylinder 22 for the tilt frame 17 FIG. 6.

FIG. 8 is a side view of articulating arm cylinder 24 for articulating arm 19 of hook hoist 10 of FIG. 1.

FIG. 9 is a side view of articulating arm 19 of the hook hoist 10 of FIG. 1.

FIG. 10 is a perspective view of the articulating arm 19 of FIG. 9.

FIG. 11 is a perspective view of the hoist frame 16 of hook hoist 10 of FIG. 1.

FIG. 12. is a perspective view of the tilt frame 17 of FIG. 6.

FIG. 13 is a perspective view of the assembled hook hoist assembly 12 of hook hoist 10 of FIG. 1.

FIG. 14 is a perspective view of the rear stabilizer assembly 39 of the hook hoist assembly 12 of FIG. 13.

FIG. 15 is a perspective view of the extension tube assembly 18 of FIG. 5.

FIGS. 16-27 show vehicle-mounted, low profile hook hoist 10 with hook hoist assembly 12 in various stages of articulation, picking up and dumping a container 67.

### DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

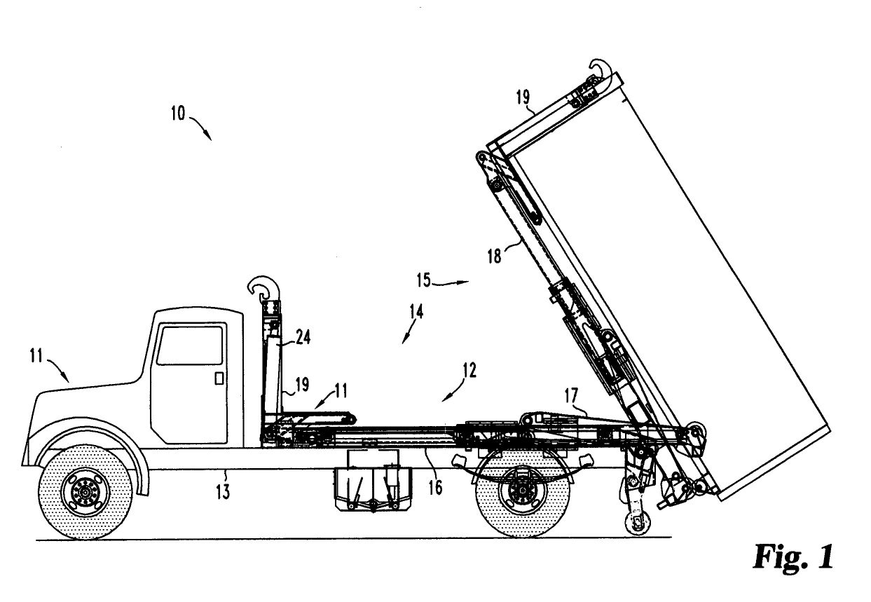

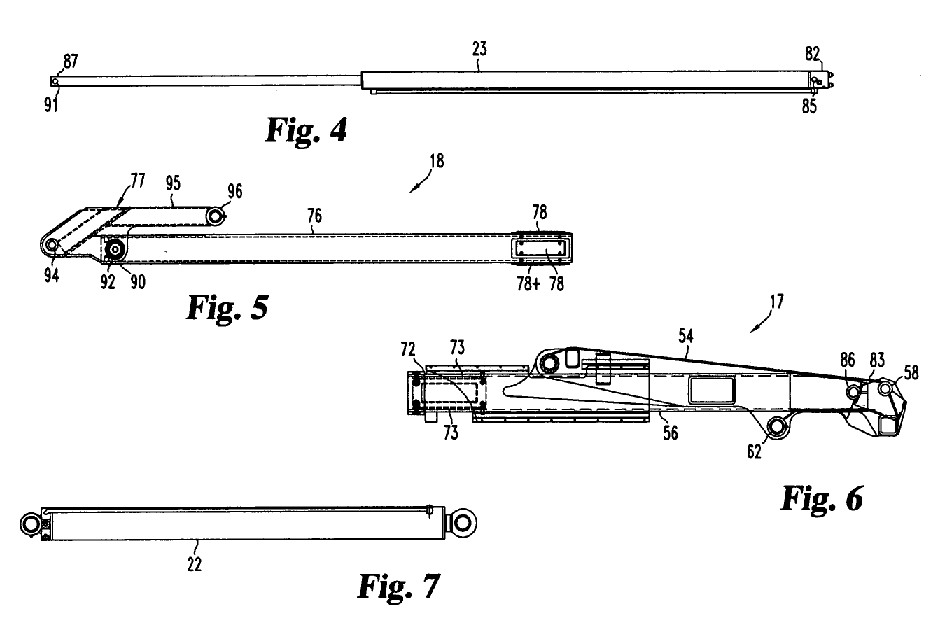

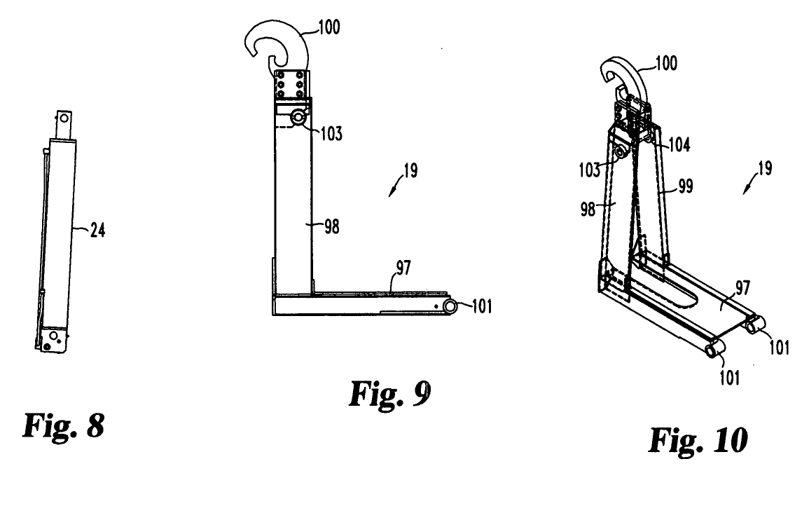

Referring to FIG. 1, there is shown a vehicle-mounted, low profile hook hoist 10 in accordance with one embodiment of the present invention. Hook hoist 10 generally includes a vehicle 11 and a hook hoist assembly 12. In FIG. 1, hook hoist assembly 12 is shown in both a forward, transport position 14 and an elevated, container dumping position 15. Vehicle 11 is a truck having a truck main frame 13 upon which is mounted hook hoist assembly 12 in any appropriate manner, as is known in the industry. Vehicle 11 may be any appropriate moving structure including, without limitation, a trailer. Hook hoist assembly 12 generally includes a hoist frame 16, a tilt frame 17, an extension tube assembly 18, an articulating arm 19 and various motive elements for moving tilt frame 17, extension tube assembly 18, and articulating arm 19, as described herein. The motive elements include any appropriate elements suitable for moving the aforementioned tilt frame 17, tube assembly 18, and arm 19 among the many positions described herein and as is well known in the industry. For example, in one embodiment, such motive elements include hydraulic cylinders 22, 23 and 24 (FIGS. 7, 4 and 8, respectively), as well as various hydraulic lines, valves and switches connecting cylinders 22, 23 and 24 with the power takeoff of vehicle 11.

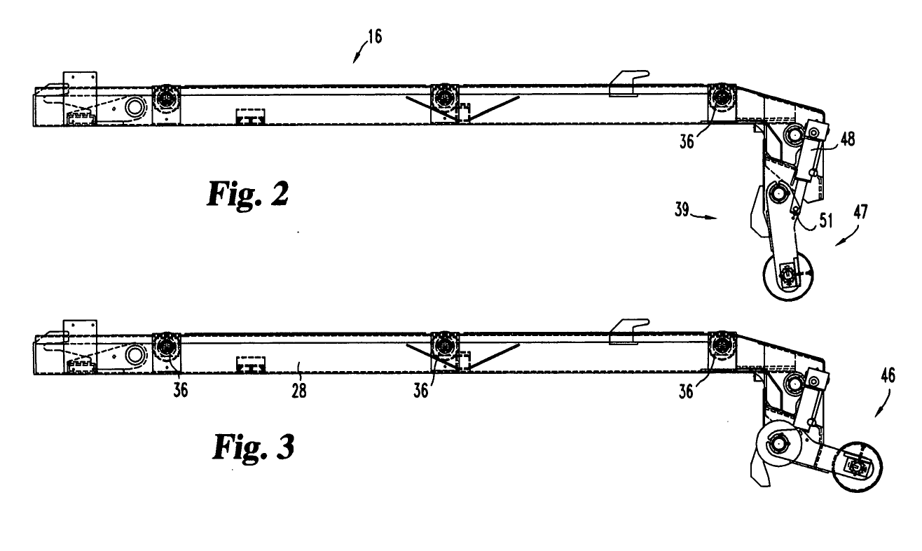

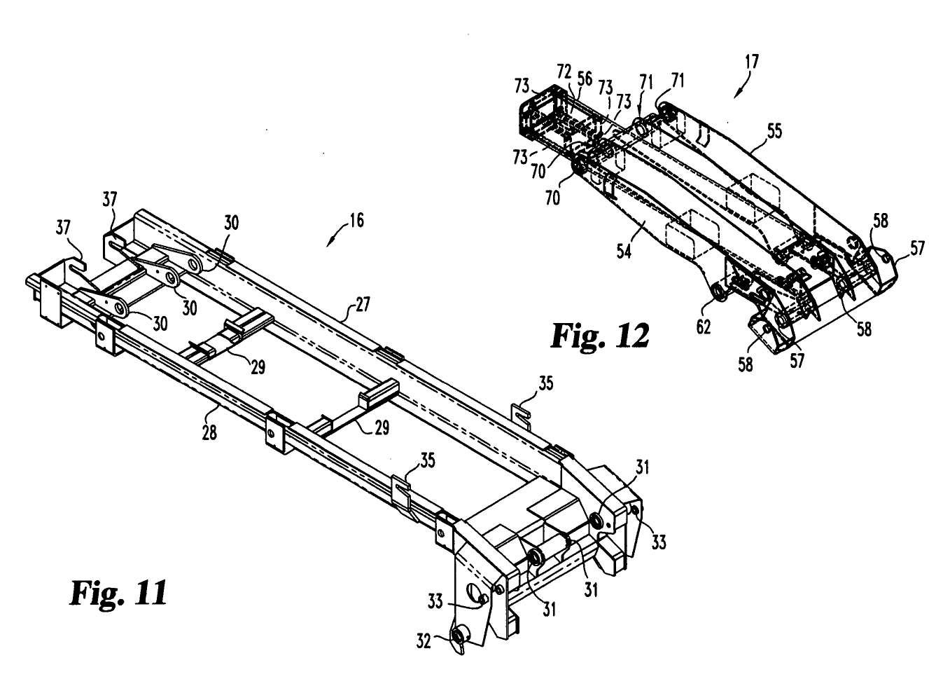

Referring to FIGS. 2, 3, 11, and 13, hoist frame 16 includes longitudinal rails 27 and 28, various transverse stiffening members, such as at 29, four forward cylinder mounts (three shown at 30), four rear tilt frame hinge mounts (three shown at 31), stabilizer hinge mounts (one shown at 32), opposing pairs of stabilizer cylinder mounts 33, slotted container retaining plates 35, three pairs of container support rollers 36, and a pair of jib stops 37. Jib stops 37 function as extension tube assembly hold down plates, as described herein. Hoist frame 16 is secured atop truck main frame 13 in any appropriate manner such as welding and/or bolts. Hoist frame 16 includes a rear stabilizer assembly 39 (FIG. 14), which includes a stabilizer pivot tube 40 and roller bracket plate assemblies 41 and 42 fixedly mounted at opposing ends of pivot tube 40, the bracket plate assemblies 41 and 42 each rotatably holding stabilizer rollers 43 and 44. Stabilizer pivot tube 40 extends coaxially between stabilizer hinge mounts 32, and a long pivot pin extends all the way there hinge mounts 32 and pivot tube 40 and is secured at the opposite ends thereof that extend outwardly of hinge mounts 32, thereby holding it in place. This enables stabilizer assembly 39 to pivot between an up, transport position 46 (FIG. 3) and a down, stabilizing position 47 (FIG. 2). A pair of hydraulic stabilizer cylinders (one shown at 48) are mounted at their upper ends to stabilizer cylinder mounts 33 and at their lower ends at cylinder mounting holes 50 and 51 defined in bracket plate assemblies 41 and 42, respectively, as shown. Hydraulic cylinders 48 are tied into the vehicle's power takeoff or other motive elements for control by the user, along with the other hoist control elements, at a control console located in the vehicle cab or at a convenient location outside the cab and proximal the hook hoist assembly 12.

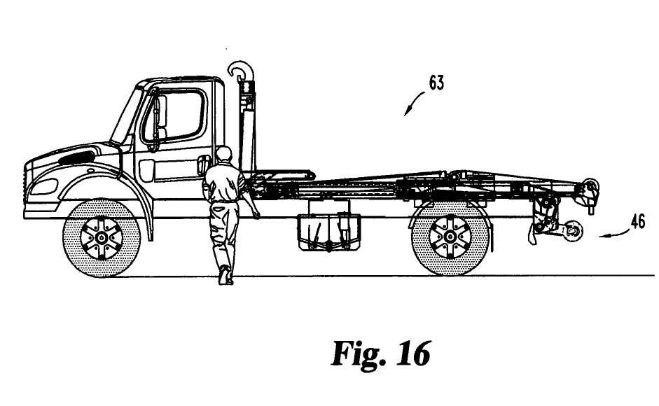

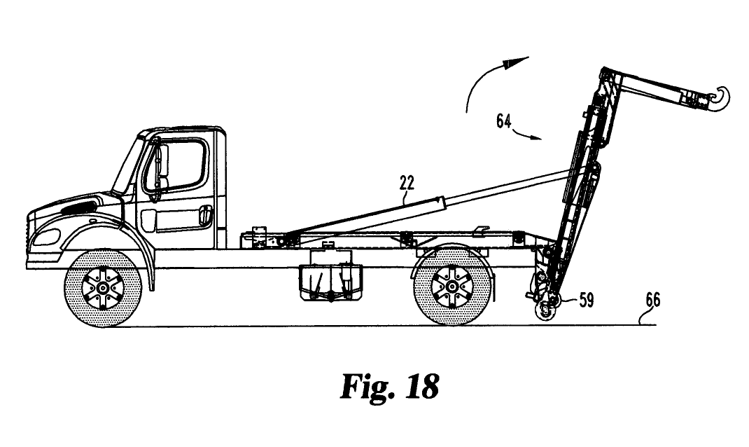

Shown in FIGS. 6, 12 and 13, tilt frame 17 generally includes left and right pivot wings 54 and 55 and a central pivot tube 56 that is rigidly connected to and between pivot wings 54 and 55. At their rear, pivot wings 54 and 55 include various support plates 57 that, with pivot wings 54 and 55, define aligned rear container roller holes 58 at which container support rollers 59 are mounted. Pivot wings 54 and 55 extend downwardly to create matching and opposing pivot mounts 61 (one shown on left mount 54) that define aligned pivot mounting holes (shown at 62 on the left side only). Tilt frame 17 is positioned atop hoist frame 16 whereby holes 62 of tilt frame 17 align with hinge mounts (holes) 31 of hoist frame 16. Mounting pins (not shown) extend through holes 31 and 62 to pivotally mount tilt frame 17 to hoist frame 16 and permit tilt frame 17 to pivot between a down, rest position 63 (FIG. 16) and a fully pivoted position 64 (FIG. 18). In one embodiment, the distance from rear tilt frame hinge mounts 31 to the slots in jib stops 37 is approximately 13 feet, and the distance rearwardly from pivot mounting holes 62 (of tilt frame 17) to rear container roller holes 58 is approximately two feet. Upon pivoting tilt frame 17 to an inclined position (i.e. FIG. 18), because rollers 59 are mounted approximately two feet rearwardly of the pivot axis 110 (at 31/62) of tilt frame 17 relative to hoist frame 16, rollers 59 drop to a very low position, proximal the ground 66, which enables rollers 59 to engage and lift a container 67 early in its rising motion, as described herein.

Pivot wings 54 and 55 define at their forward ends aligned cylinder mounting holes 70 and 71. Two hydraulic tilt frame cylinders (one shown at 22) are mounted at their forward ends to forward cylinder mounts 30 of hoist frame 16, and at their rearward ends to pivot wings 54 and 55 at cylinder mounting holes 70 and 71. Tilt frame cylinders 22 thus are operable to move tilt frame 17 between its down, rest position 63 and its inclined position 64. Central pivot tube 56 has a rectangular cross section and on all four inside sides at its forward end 72, pivot tube 56 is provided with bearing plates 73.

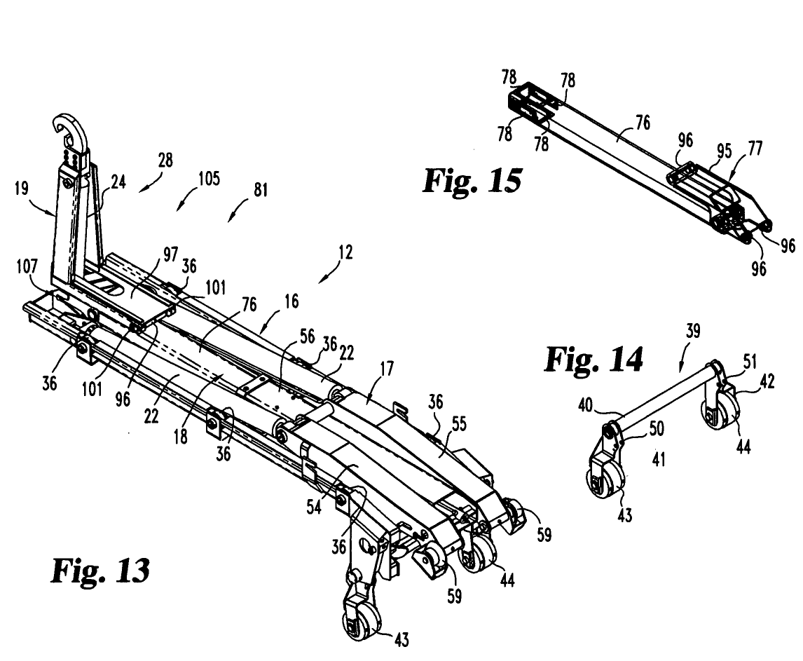

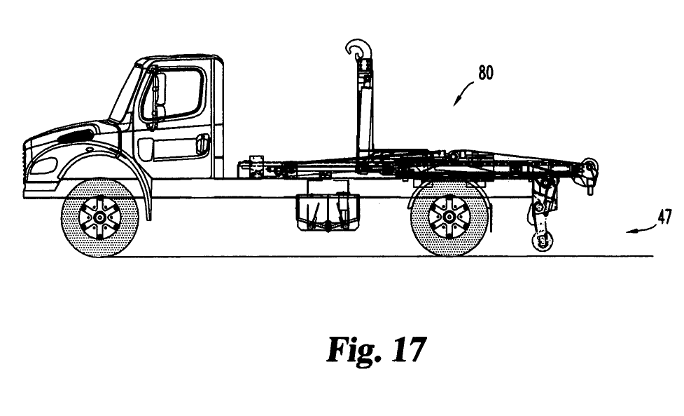

Referring to FIGS. 5, 13 and 15, extension tube assembly 18 includes a box tube 76 and a jib support 77. Box tube 76 has a rectangular cross section and at its inboard end is provided with bearing plates 78 on all four outside sides thereof. Box tube 76 is sized to be telescopically received within pivot tube 56 to slide between a retracted position 80 (FIG. 17) and an extended position 81 (FIGS. 13 and 16). The bearing plates 78 of box tube 76 and bearing plates 73 of pivot tube 56 are generally rectangular and are sized to provide sufficient support for box tube 76 to extend its full distance out the end of pivot tube 56 without sagging. Extension tube assembly 18 is moved between its extended and retracted positions by extension tube cylinder 23, which extends within both pivot tube 56 and box tube 76 and is connected at its inboard end 82 to the rear end 83 of pivot tube 56 at mutually aligned connection holes 85 and 86, respectively, by a pin (not shown). At its outboard end 87, cylinder 23 connects to the outboard end 90 of box tube 76 at mutually aligned connection holes 91 and 92, respectively, by a pin (not shown).

Jib support 77 extends up and rearwardly from the outboard end 90 of box tube 76, forming a cantilevered jib connection arm 95 with a jib bearing assembly 96 connected at the rearward end thereof. Jib connection arm 95 is spaced above box tube 76 a distance sufficient to enable extension tube assembly 18 to retract all the way into pivot tube 56, whereby the forward end 72 pivot tube 56 extends between box tube 76 and arm 95. At its forward end, jib support 77 defines cylinder mounting bearings 94.

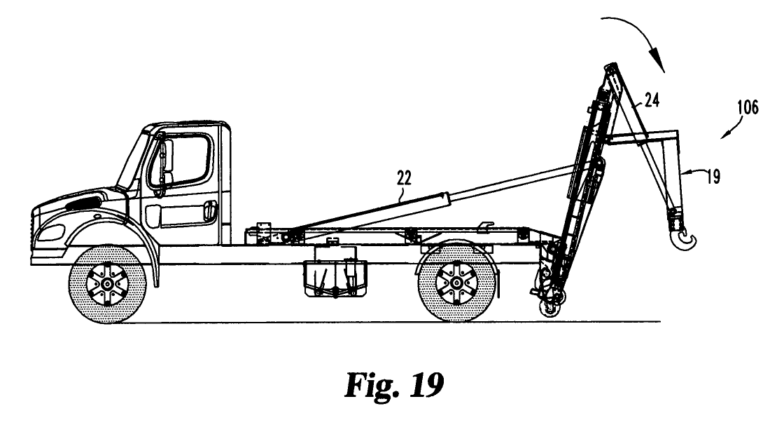

Referring to FIGS. 9, 10 and 13, the jib or articulating arm 19 generally includes a base 97, a pair of support arms 98 and 99 extending upwardly from the forward end of base 97, and a container hook 100 rigidly connected to the top of arms 98 and 99: Base 97 includes at its rear a pair of jib mounting bearings 101 and defines a central clearance slot 102 sized to permit articulating arm cylinder 24 to extend therethrough. Just below hook 100, are provided cylinder mounting bearings 103 and 104. Articulating arm 19 is sized and configured to rest atop jib support 77 and to be connected thereto by pins (not shown) extending through the aligned holes of cylinder mounting bearings 96 and jib mounting bearings 101, which permits arm 19 to pivot between a retracted rest position 105 (FIG. 13) and a rotatably extended position 106 (FIG. 19). Articulating arm cylinder 24 extends from cylinder mounting bearings 103 and 104 of arms 98 and 99, through slot 102 and down to cylinder mounting bearings 94 of jib support 77. Extension and retraction of cylinder 24 rotates articulating arm 19 between the retracted rest position 105 and the rotatably extended position 106. The lower end of articulating arm cylinder 24 is connected with cylinder mounting bearings 94 by a pin 107 (one shown in FIG. 13) that extends outwardly from opposing sides thereof to form locking pins that engage with jib stops 37 (forward extension tube retaining plates) (FIG. 13) when extension tube assembly 18 is fully extended. This serves to hold down the forward end of extension tube assembly 18 and the container 67 connected thereto during transport.

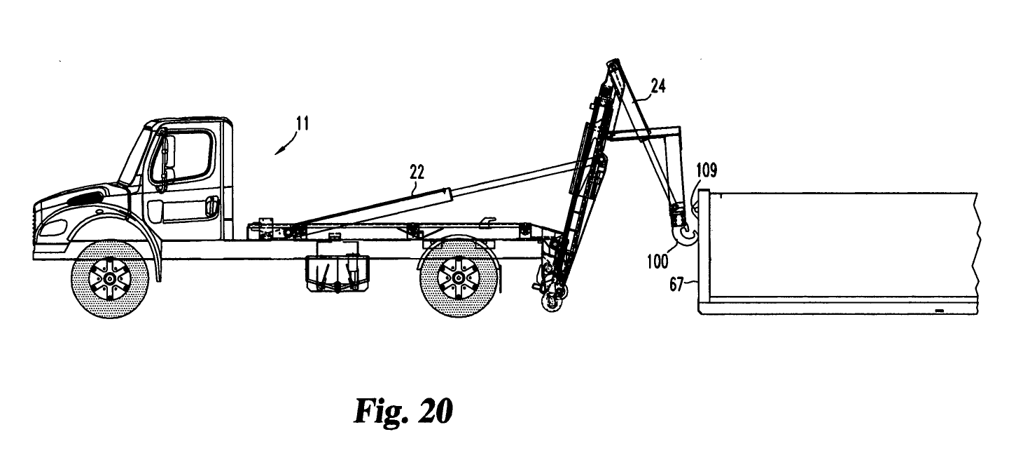

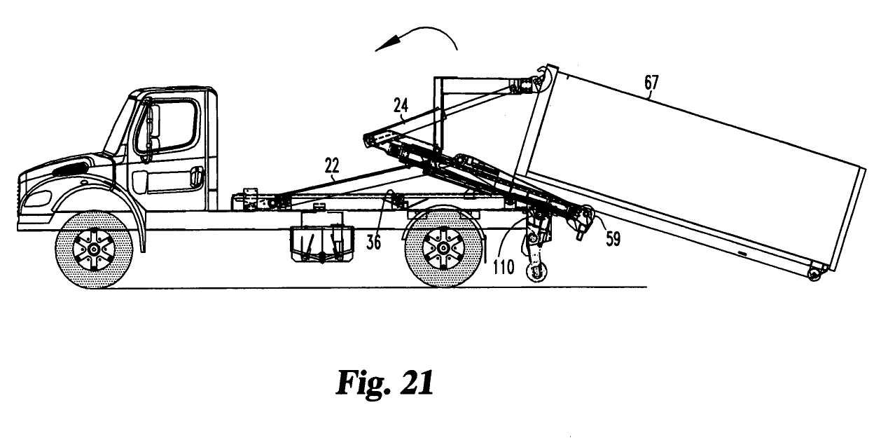

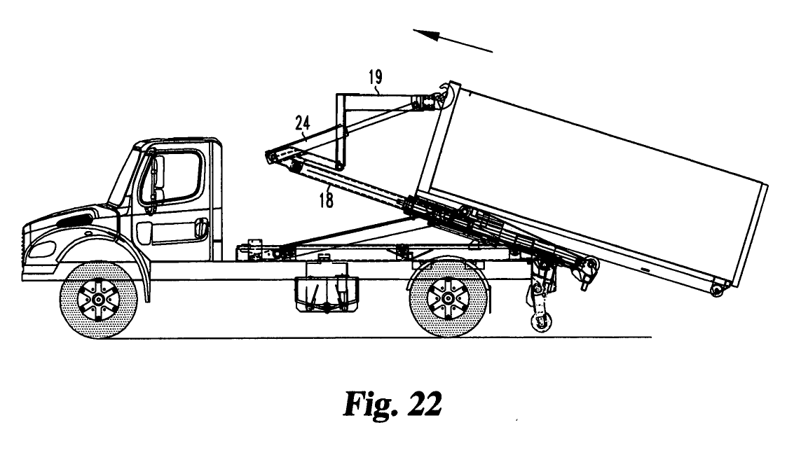

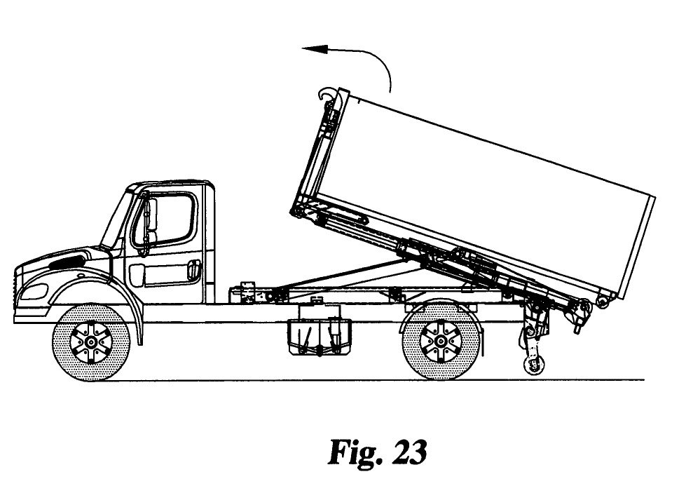

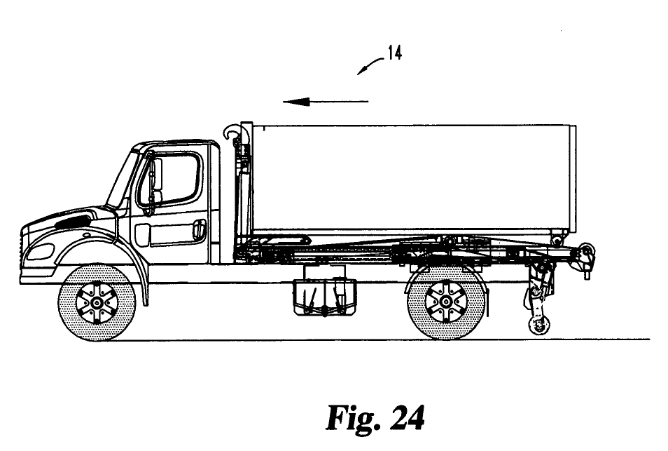

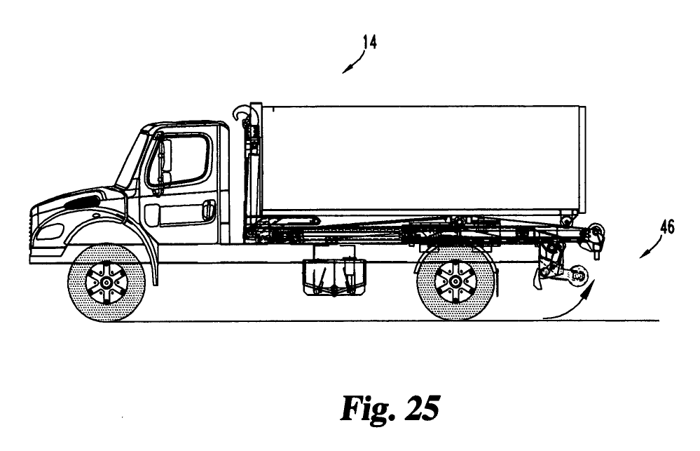

In use, to load a container 67 onto low profile hook hoist 10, starting in the transport position shown in FIG. 16, the user activates stabilizer cylinders 48 to rotate rear stabilizer assembly 39 from the up, transport position 46 to the down, stabilizing position 47, and activates extension tube cylinder 23 to retract extension tube assembly 18 and articulating arm 19 to the retracted position 80 (FIG. 17). Tilt frame cylinders 22 are then actuated to pivot tilt frame 17 to its fully pivoted position 64 (FIG. 18), whereby rear rollers 59 are positioned close to ground 66. Articulating arm cylinder 24 is then actuated to pivot articulating arm 19 to its rotatably extended position 106 (FIG. 19). Vehicle 11 is then moved rearwardly to position hook 100 proximal to the grab bar 109 of a container 67 (FIG. 20). Cylinders 22, 23 and 24 are then actuated as necessary by the user to engage hook 100 with grab bar 109 and to lift container 67 upwardly until it rises up onto rear rollers 59, which as shown in FIG. 21, are not yet above either the rear pivot axis 110 (at pivot mounting holes 62 of tilt frame 17) or the container support rollers 36 of hoist frame 16. Through further extension of extension tube cylinder 23 to extend extension tube assembly 18, followed by appropriate actuation of articulating arm cylinder 24 and tilt frame cylinders 22, container 67 can be moved all the way forward while maintaining a low tilt angle (FIGS. 22-24). In one embodiment, where vehicle 11 and its hoist frame 16 are sized so that the container 67 ultimately sits atop rollers 36 about 47 inches off the ground, a 12 foot container 67 can be loaded with the container not exceeding about 29 degrees tilt on level ground 66; a 14 foot container 67 without exceeding about 26 degrees; a 16 foot container without exceeding about 23 degrees; and, an 18 foot container without exceeding about 20 degrees. Finally, before transport, the rear stabilizer assembly 39 is retracted to its up, transport position 46 (FIG. 25).

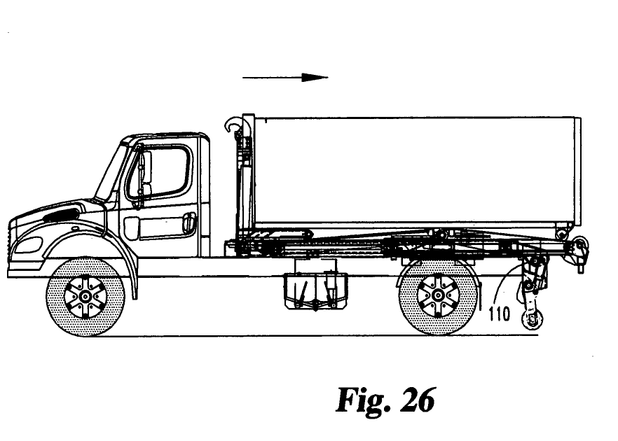

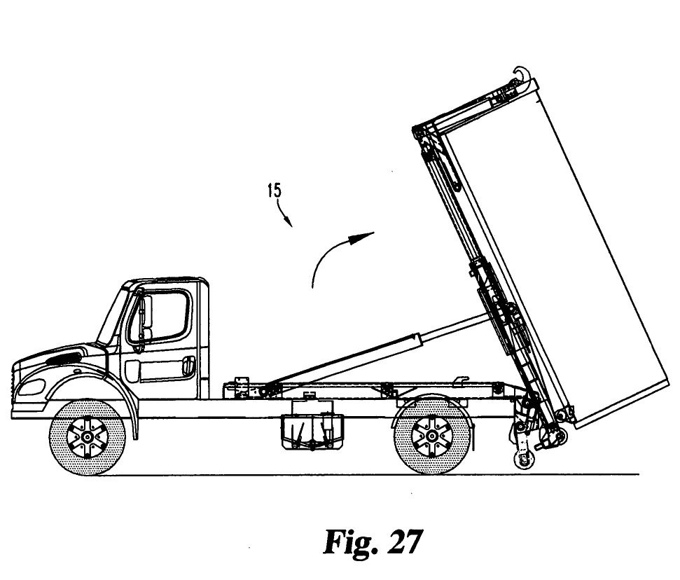

To dump the contents of container 67, extension tube cylinder 23 is first retracted slightly to allow the articulating arm 19 and its pins 107 to clear jib stops 37 (FIG. 26). Tilt frame cylinders 22 are then actuated to pivot tilt frame 17 about its axis at 110 from the forward, transport position 14 to its elevated, container dumping position 15 (FIGS. 1 and 27).

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A vehicle-mounted hook hoist for loading, transporting, dumping and unloading material handling containers, comprising:
a vehicle having a main frame;
a hook hoist assembly including a hoist frame, a tilt frame, an extension tube assembly, an articulating arm and motive means for moving said tilt frame, extension tube assembly and articulating arm;
wherein said hoist frame has a rear hinge mount and is mounted to said main frame, said tilt frame has a rear and a pivot mount and is pivotally mounted at its pivot mount to the rear hinge mount of said hoist frame, and said extension tube is telescopically connected with said tilt frame to extend between a retracted position and an extended position; and,
wherein said articulating arm is pivotally connected to said extension tube assembly to pivot between a retracted rest position and a rotatably extended position, and wherein said articulating arm includes a hook configured to engage with and move a container onto and off of said vehicle.
